(19) United States
(12) Patent Application Publication
(10) Pub. No.: US 2015/0317660 A1
(43) Pub. Date: Nov. 5, 2015

(54) APPARATUS AND METHOD FOR ENHANCING ELECTRONIC COMMERCE VIA PARTICIPATION INCENTIVES

(71) Applicant: Raphael Aguilar Trotta, Belo Horizonte (BR)

(72) Inventor: Raphael Aguilar Trotta, Belo Horizonte (BR)

(21) Appl. No.: 14/266,827

(22) Filed: May 1, 2014

(51) Int. Cl. G06Q 30/02; G06Q 30/06

(52) U.S. Cl. CPC G06Q 30/0214; G06Q 30/06

(57) ABSTRACT

An apparatus and method for enhancing electronic commerce through a dynamic hierarchal protocol of scalable participation incentives for both buyers and sellers. The apparatus and method of use collects a brokerage fee from each consummated transaction and distributes the fee to select participants according to their special and/or relational association to the consummated the transaction. Periodically the hierarchal relationships of participating individuals are reorganized based relative participation.

### FIELD OF THE PRESENT DISCLOSURE

This disclosure relates generally to the field of electronic commerce and more particularly to an apparatus and method for enhancing electronic commerce through a dynamic hierarchal protocol of scalable participation incentives for both buyers and sellers.

### BACKGROUND OF THE RELATED ART

Electronic commerce, or e-commerce, is the buying and selling of goods and services by both businesses and individuals electronically, typically over the Internet. E-commerce encompasses both the sales and purchasing of electronic content such as digital entertainment that may be directly downloaded for immediate consumption, as well as conventional goods and services that must be physically shipped to the purchaser after the transaction is consummated.

There exists several Internet websites that facilitate e-commerce. Many are designed to foment the sales of the goods and services of a single particular manufacturer or distributor whereas others are more comparable to electronic market places providing a platform for multiple buyers and sellers to convene connecting supply with demand. Marketplace-style Internet websites typically do not benefit directly from the profits generated through the sale of any particular good or service, and therefore, must be monetized in some other way. Many such Internet websites are monetized at least partially through advertising taking advantage of the traffic such Internet websites generate. However, the most common source of revenue for marketplace-style Internet websites is the fees charged to the sellers. Some market-place style Internet websites charge flat fees to sellers while others charge scalable fees related to the dollar value of consummated transactions. Therefore, while sellers obtain the benefit of finding buyers for their goods and services and the associated profits, they must typically pay to utilize most marketplace-style Internet websites. There does not exist a marketplace-style Internet website that provides sellers with additional incentives to utilize the particular website, apart from or in addition to its ability to locate consumers.

While such platforms serve their core purpose of bringing together supply and demand, they do little to incentivize patrons to remain loyal to any one particular marketplace-style Internet website. Buyers and sellers who are e-commerce savvy often utilize several different marketplace-style Internet websites. This causes such market-place style Internet website sites to compete for patronage through optimizing various convenience factors. These methods may include: the effectiveness of search tools; the selection size of goods and services; the amount or percentage of the fees charged; and the ease of consummating transaction formalities. Such techniques may create Internet website preferences among buyers and sellers but they do little to incentivize the development of any significant loyalty toward any one particular marketplace-style Internet website.

In a different type of business strategy, known as multi-level or network marketing, sellers are compensated for not only for sales they generate, but also for the sales generated by sellers whom they recruit. Typically, a portion of the newly recruited seller's compensation will be awarded to the recruiting party for some period of time. This arrangement creates an incentive for sellers to find and recruit additional sellers and leverages and profits from relationships between the newly recruited sellers and a greater number of potential buyers. Typically, multi-level or network marketing organizations represent only one or a small number manufacturers or distributors. In such arrangement, this business strategy tends to be successful only until the market becomes so saturated with sellers that existing sellers have difficulty generating adequate sales. However, if a multi-level marketing or a network marketing business strategy was applied to a marketplace-style Internet website there would be a much larger potential range of goods and services and market saturation would be much more difficult to achieve. Further, such an arrangement would add an additional incentive for sellers to exclusively utilize a particular marketplace-style Internet website potentially creating stronger website loyalty among sellers.

Traditional multi-level marketing or network marketing business strategies have static hierarchal protocols. This means that those who join early and subsequently recruit sellers may enjoy a portion of the subsequently recruited sellers compensation for some period of time, sometimes for as long as the business model stays intact. While such arrangements create a strong incentive to join such organizations early and subsequently recruit additional sellers, static hierarchal models fail to incentivize sellers to increase performance after they join and can be discouraging for prolific sellers who join the organization relatively late and continuously share their compensation with less productive sellers with more seniority. A more effective incentive model might rank participants according to both recruitment seniority and performance, wherein a seller with exceptional performance might be able to move up the hierarchal organizational structure relative to a less productive seller with more seniority. By accounting for both seniority and productivity through a dynamic hierarchal protocol, sellers could be incentivized to both recruit additional sellers and continue to proactively find buyers.

Another disadvantage of a traditional multi-level marketing or network marketing is that they only reward sellers. This may be partially due to the fact that many such organizations are designed promote the sales of the goods and services of only one or a small number of manufacturers or distributors and therefore do not anticipate a high number of repeat buyers, or perhaps, because historically it has been more procedurally difficult to track the purchase history of individual buyers. However, marketplace-style Internet websites not only anticipate but attempt to cultivate repeat buyers and are capable of tracking a buyer's purchasing history with relative ease. If a marketplace-style Internet website offered participation incentives to buyers for purchases and/or for introducing additional buyers, such websites may create buyer loyalty beyond what can be achieved through convenience factors alone. More complex, dynamic hierarchal protocols may provide participation and recruitment incentives for both buyers and sellers, including those individuals who qualify as both buyers and sellers.

The present disclosure distinguishes over the related art providing heretofore unknown advantages as described in the following summary.

### BRIEF SUMMARY OF THE INVENTION

The present disclosure relates to an apparatus and method for enhancing electronic commerce through a dynamic hierarchal protocol of scalable participation incentives for both buyers and sellers.

The disclosure describes an apparatus and method that foments both the buying and selling process through Internet websites especially market-place style Internet websites through the use of scalable participation incentives in the form of brokerage fees charged to buyers and subsequently distributed among one or more individuals according to their relationship, hierarchal or otherwise, to the consummated transaction and other factors. An individual's hierarchal relation to the consummated transaction is determined by a variety of parameters including some parameters fixed at the outset of participation and others periodically altered pursuant to the individual's continued relative participation in the system.

The apparatus is capable of receiving and storing protocol limitations which dictate the manner in which participating individuals are organized in a programmable computer, programmed with and capable of executing executable software or firmware or some combination thereof. Pursuant to the manner in which the individuals are initially organized, the individual's subsequent participation, and other relational factors, the apparatus periodically reorganizes the participating individuals' hierarchal relationships and distributes participation incentives appropriately.

At the outset, participating individuals must be arranged in hierarchal levels. The number of levels and the number of participating individuals assigned to each level are both system parameters that may initially be set by those managing the apparatus and method of use. These system parameters are determined as a function of the overall number of participating individuals and should be scalable such that when additional individuals choose to participate in the disclosed apparatus and method of use, the number of levels and number of individuals per level may be scaled accordingly. Initial hierarchal organization of individuals may be arranged in a number of ways such as according to the chronological order of participation, initial transaction size, or even random selection. These are listed as exemplar and are not meant to be limiting.

There must be an initial hierarchal arrangement but the manner of selecting the initial arrangement is less critical than the manner in which the hierarchal arrangement is subsequently dynamical reorganized. Different embodiments may choose to organize the initial participating individuals differently. Once the initial organization is arranged and a transaction is consummated the apparatus will collect a brokerage fee from the buyer and distribute it according to the predetermined protocol to appropriate associated individuals. A portion of the brokerage fee may be distributed to individuals associated with both the buyer and a portion may be distributed to individuals associated with the seller. In an exemplar embodiment where the brokerage fee is 5 percent, 2 percent may be distributed to the buyer's associates and the remaining 3 percent may be distributed to the seller's associates. The percentage split between buyer and seller may vary. In some embodiments such split may totally exclude either the buyer or seller depending on the programmed limitations and parameters. Some embodiments may include an additional percentage for the administration of the system. The percentages may be altered by those managing the system to best foment electronic commerce.

The individuals associated with the buyer and/or seller who receive a portion of the brokerage fee are individuals situated on a higher levels and/or individuals that have a special relationship to the buyer or seller. They may be the individual who initially recruited the buyer or seller or they may be assigned to the buyer or seller pursuant to some other predetermined criteria such as a preexisting relationship in other social networks that are integrated with the presently disclosed apparatus and method of use. Much like traditional multi-level or network marketing, individuals on higher levels will collect brokerage fees from associated individuals located on lower levels. However, unlike traditional multi-level marketing or network marketing, the instant disclosure allows individuals to periodically advance to higher levels as a reward for exceptional participation.

Participation is calculated and recorded in the form of punctuation. When an individual participates in commerce directly via the presently disclosed apparatus and method of use, whether it be as a seller or as a buyer, the individual receives credit that is reflected in an a punctuation value. In some embodiments, an individual may also receive punctuation value for recruiting new participants, the in-system commercial activity of their recruits, and the in-system commercial activity of those with whom the individual has a special relation such as a preexisting relationship in another social media network.

Periodically the hierarchal organization is partially rearranged allowing some portion of each level to advance a level and consequently reducing the level of an equivalent number of participating individuals. Reorganization is directed by individuals' punctuation. Those who have exhibited exceptional performance within the last period and therefore have a relatively high punctuation value are invited to advance to a higher level while the level of those individuals who exhibited relatively low performance and have a relatively low punctuation value is reduced. Such a credit accruing and advancement arrangement incentivizes individuals to utilize the system rather than competing electronic commerce Internet websites whenever possible thereby fostering a loyalty greater than what can be achieved through convenience factors and/or pricing alone.

After the predetermined temporal period expires, the hierarchal organization is reorganized according to the participants' punctuation and the reorganization protocol and all participants' punctuation values are reset to zero. Subsequently, a new temporal period begins giving the participants a fresh opportunity to generate commercial activity and potentially accrue a relatively high punctuation value that will allow for an increase in their hierarchal status. The temporal length of such predetermined punctuation accrual period is a system limitation that may be set or altered by those managing the apparatus and method of use to continually incentive vigorous participation and foment commerce.

This disclosure teaches certain benefits in construction and use which give rise to the objectives described below.

A primary objective inherent in the instant disclosure is to describe an apparatus and method of enhancing electronic commerce through a hierarchal protocol of scalable participation incentives for both buyers and sellers to foment the buying and selling process.

Another objective inherent in the instant disclosure is to describe an apparatus and method of enhancing electronic commerce through a hierarchal protocol of scalable participation incentives for both buyers and sellers to foster marketplace loyalty among both buyers and sellers.

A further objective inherent in the instant disclosure is to describe an apparatus and method of enhancing electronic commerce through a hierarchal protocol of scalable participation incentives based on scalable participation incentives for both buyers and sellers that alleviate some of the traditional limitations of multi-level or network marketing.

A still further objective inherent in the instant disclosure is to describe an apparatus and method of enhancing electronic commerce through a hierarchal protocol of scalable participation incentives which integrate automatically with social networks and leverages personal relationships of both buyers and sellers.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE DRAWING(S)

The accompanying drawings are diagrams that illustrate various exemplary implementations and are part of the specification. The illustrated implementations are proffered for purposes of example, not for purposes of limitation. Illustrated elements and steps will be designated by numbers. Once designated, an element or step will be identified by the identical number throughout. Illustrated in the accompanying drawings is at least one of the best mode embodiments of the present disclosure. In such drawings:

FIG. 1 is a block diagram of the hierarchal organization of an exemplary sampling of system participants and a schematic of the component parts of an exemplary embodiment of the presently disclosed system;

FIG. 2 is an block diagram of the hierarchal organization of an exemplary sampling of system participants featuring the distribution of a brokerage fee of an exemplar transaction;

FIG. 3 is a block diagram of the hierarchal organization of an exemplary sampling of system participants featuring punctuation values representing participation performance achieved in an exemplary predetermined temporal period;

FIG. 4 is a block diagram of the hierarchal organization of an exemplary sampling of system participants featuring select individual's whose hierarchal position will be reduced at the end of an exemplary period based on relative punctuation values;

FIG. 5 is a block diagram of the hierarchal organization of an exemplary sampling of system participants featuring select individual's whose hierarchal position will be increased at the end of an exemplary period based on relative punctuation values;

FIG. 6 is a block diagram of the hierarchal organization of an exemplary sampling of system participants featuring the occupying new hierarchal positions and zeroed punctuation values at the beginning of a new period.

### DETAILED DESCRIPTION OF THE EXEMPLARY EMBODIMENT

The above described drawings illustrate an exemplary embodiment of an apparatus and method of use in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example, and that it should not be taken as a limitation in the scope of the present apparatus and method of use.

Described now in detail is an apparatus and method of enhancing electronic commerce participation and loyalty through a dynamic hierarchal protocol of scalable participation incentives for both buyers and sellers. Such participation incentives are provided in proportion to the participant's hierarchal position, the frequency and magnitude of consummated in-system commercial transactions that the participant is associated with, as well as the frequency and magnitude of consummated in-system commercial transactions related to other participants with whom the participant has special relationship. Special relationships may be created through recruitment to the system or through an association in an unrelated social network.

The hierarchal protocol is dynamic in that periodically a participant's hierarchal position may be altered pursuant to the participant's commercial activity level. Activity level is measured and recorded in the form of a punctuation value that is increased with each associated in-system commercial transaction consummated. Periodically, participants with relatively high punctuation values are moved to a higher position in the hierarchal organization and those with relatively lower punctuation values are moved to a lower position. The punctuation values of all participants' are subsequently zeroed creating a continuing incentive for participants to recruit and encourage in-system commercial activity. Such dynamic reorganization creates an ongoing participation incentive for both new and old participants and fosters system loyalty unlike other electronic commerce systems.

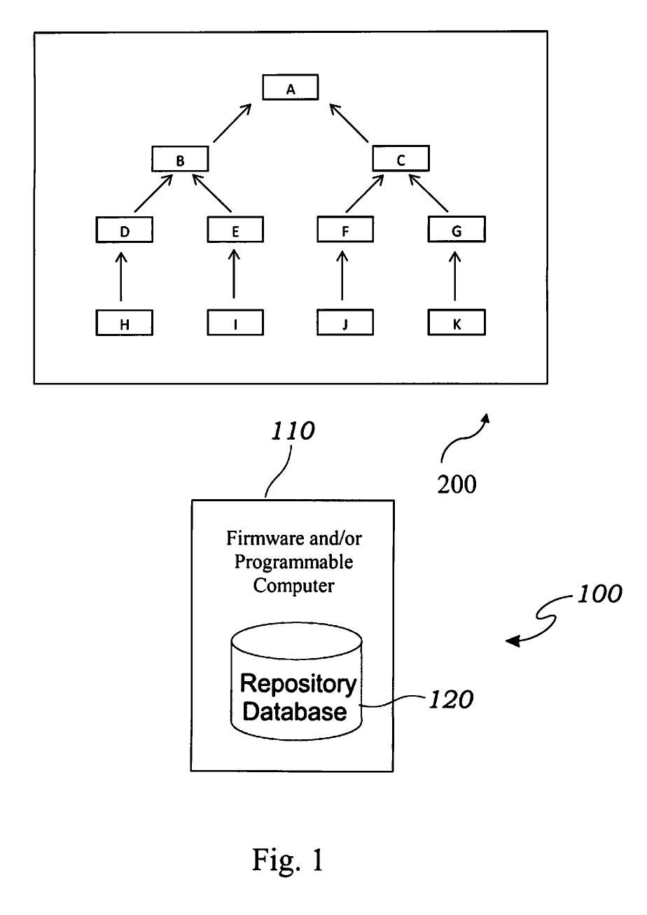

In FIG. 1, the lower illustration is a schematic depicting an exemplary embodiment of the presently disclosed system 100. The system 100 comprises firmware and/or a programmable computer 110, programmed with and capable of executing software, or some combination thereof, that directs and executes the presently described method. The system 100 is capable of both receiving and transmitting data and control signals through interactive portals and features a repository database 120 for storing relevant input, calculations, and boundary conditions. In some embodiments, the apparatus 100 is capable of receiving and transmitting data and control signals via Internet protocol. In other embodiments, the apparatus is capable of receiving and transmitting data and control signals via compatible peripheral hardware. Embodiments incorporating both Internet protocol as well as peripheral hardware are also possible.

The system's 100 portal may begin with a login step for security purposes. Once the identity of a participant is confirmed, the system 100 may allow the participant to access limited information about other participants and their social network. In some embodiments, participants may log into a secure portal to complete their sales and purchases directly from other sellers and buyers. In other embodiments, participants may communicate through the system 100 in an open and unsecured platform designed to assist the participants locate or advertise the products they are interested in buying or selling. Other embodiments may provide further information regarding participants, such as the number of participants associated with a particular participant and/or a participant's current hierarchal position or punctuation value.

The upper portion of FIG. 1 is a block diagram of the hierarchal organization 200 of an exemplary sampling of system participants. Such sampling is a limited representation illustrating the organization of the participants in the presently disclosed apparatus and method of use. The hierarchal order features a greater numbers of participants existing on lower levels with lower level participants assigned or associated with select high level participants. In FIG. 1 each unique participant is labeled with a letter for distinction (A, B, C, D, E, F, G, H, I, J and K.) and hierarchal relational associations are depicted with arrows. These parties are intended to be representative of the various exemplary interested parties that may want to engage in electronic commerce. It is important to note that FIG. 1 does not show special relationships such as the relationship created through recruitment to the system or an association in a separate social network.

The system 100 may be adapted to include as many new participants as are interested in participating. The system 100 integrates participant by initially introducing new participants to the hierarchal organization 200. In some embodiments this may be done by inserting new participants to the lowest level and assigning a hierarchal relationship to one or more participants at the level above. As each new participant participates in in-system electronic commerce and recruits further new participants into the system, the new participant's punctuation value will increase providing the opportunity to rise in the hierarchal organization 200.

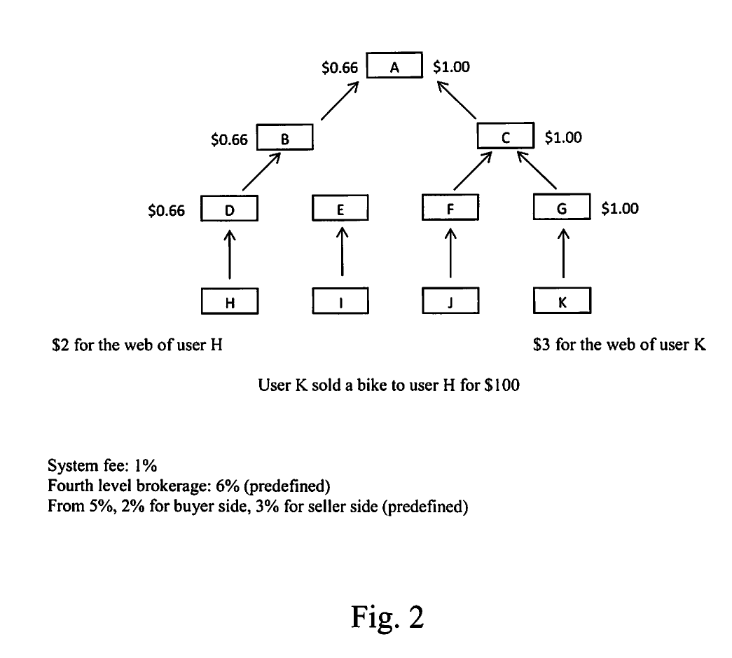

FIG. 2 is a block diagram of the hierarchal organization 200 of an exemplary sampling of system participants featuring the distribution of a brokerage fee of an exemplar transaction. Namely, participant K selling a bike for $100 to participant H with a brokerage fee of six percent (6%) wherein one percent (1%) is kept by the system, two percent (2%) is paid to those associated with the buyer and three percent (3%) is paid to those associated with the seller. In this example. participants G, C, and A are associated with the seller and each received a portion of the three percent (3%). If split evenly, they each receive one dollar ($1). Participants D, B, and A are each associated with the seller and each receive a portion of the two percent (2%). As before, if slit evenly, each will receive sixty seven cents ($0.67). Participant A is associated with both the buyer and seller and therefore will received a total of one dollar and sixty seven cents ($1.67). In some embodiments, associated participants may share the brokerage fee unequally, varying according to level or pursuant to a formula, and/or making allotments for those participants with special relationships with the buyer, seller, or both.

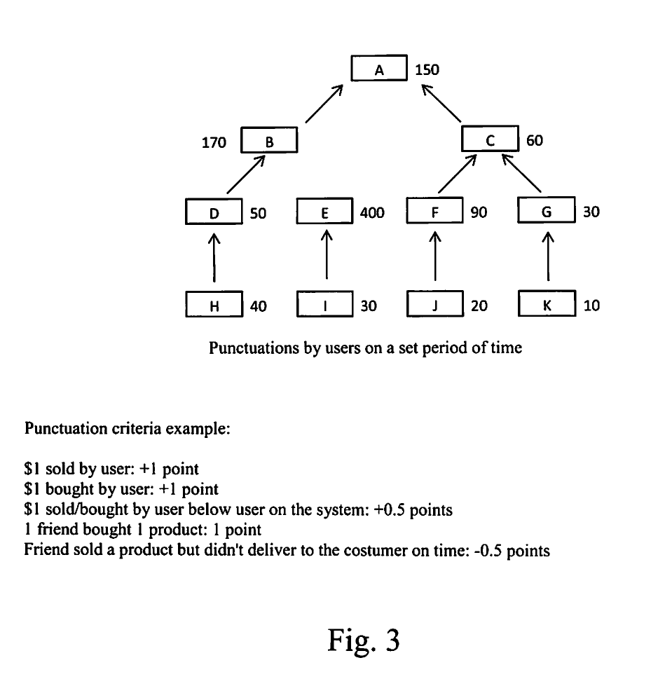

FIG. 3 is a block diagram of the hierarchal organization 200 of system participants featuring punctuation values representing participation performance achieved in an exemplary predetermined temporal period. Participants A through K are each illustrated adjacent a punctuation value representing hypothetically accrued of credit for commercial transactions consummated by the participant or by others associated with the participant. Those administering the presently disclosed apparatus and method of use must establish an exchange rate for punctuation value that accounts for both the monetary value of the consummated transaction and the participant's relational proximity. For example, one embodiment might award one point of punctuation value for each dollar bought or sold and half a punctuation point for each dollar sold by an associational participant. Other embodiments may choose to award a point of punctuation per transaction regardless of monetary value. Punctuation value may be removed as well such as when the purchasing participant is unsatisfied with the product quality or the timeliness of shipping.

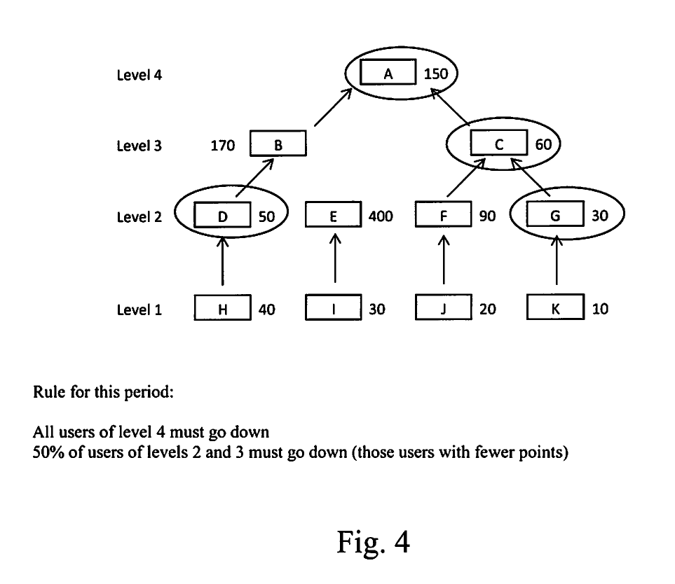

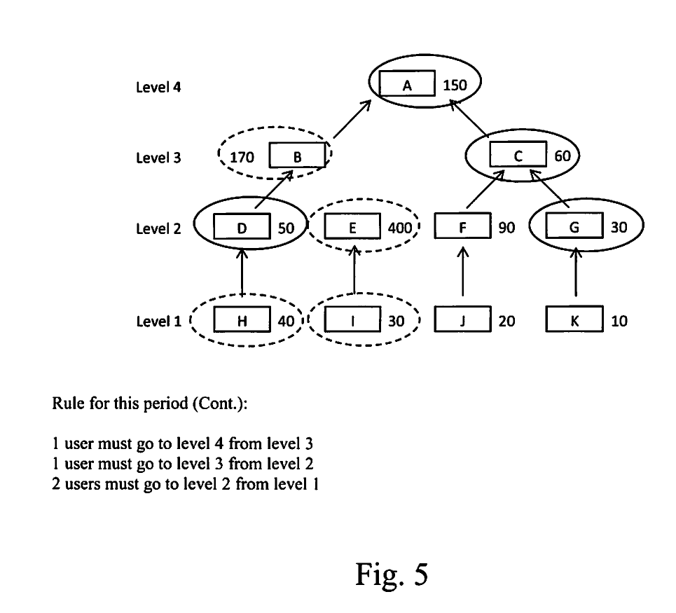

Once the punctuation value has been awarded it is stored in the repository database 120 and the system 100 may compare values assigned to participants to determine which participants in each level have accumulated the highest punctuation value. Participants with the highest punctuation value in each level may be eligible to be reassigned to a higher level. Likewise, participants with the lowest punctuation values in each level may be reassigned to a lower level. The number of participants that will be reassigned in each level may depend on system 100 rules and boundary conditions designed to best incentive participant activity. FIGS. 4 and 5 graphically illustrate this identification and selection process.

In FIG. 4 participants D and G are identified in level three as having the lowest punctuation value (with a solid oval around the box representing the participant). In level two participant C is similarly identified. Each of these participants will be reassigned to the level below and be replaced by those participants currently located in the level below with the highest punctuation values. The number or percentage of participants in each level that are reassigned to a higher or lower level is set by those managing the system. In some embodiments there might exist additional rules that govern the dynamic reorganization of the hierarchal organization 200. For example, in FIG. 4 participant A is identified to be reassigned to a lower level even though there are no other participants against which to compare participant A's punctuation value. This may be necessary or preferred in a hierarchal organizations 200 wherein the highest level contains a single participant. Some embodiments may have a rule that the highest level participant always moves down at the end of each accrual period. Other embodiment may have several participants in the highest level and thereby eliminate this need.

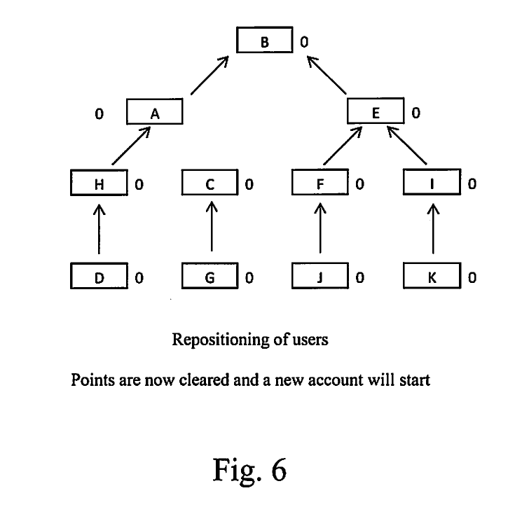

FIG. 5 identifies the participants with the highest punctuation values in each level that have been identified to be reassigned to a higher level with a dashed oval. After such reassignment, all participants' punctuation values will be reduced to zero and a new accrual period will begin as illustrated in FIG. 6.

The hierarchal organization 200 is scalable to accommodate as many participants as possible. In some embodiments, the number of levels, or the number of participants per level may be adjusted so that the ratio of lower level participants associated to a higher level participants maintains the same. In such embodiment, participants may be may be reassignment before the end of an accumulation period to accommodate new participants. Other embodiments may merely increase the number of participants associated with the higher level participants and reassign participant levels only at the termination of an accrual period. Such organizational protocol may be adjusted to best foment participation and encourage the consumption of commercial transactions.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in to the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventors believe that the claimed subject matter is what is intended to be patented.

What is claimed is:

1. A method for fomenting electronic commerce by incentivizing buyers and sellers to loyally participate as well as recruit others to participate, including the steps of:
1) prompting participants, which may be buyers and sellers, or both, to input information into the system regarding at least one product that the participant proposes to sell or wishes to purchase, including price, features, warranties, and other relevant information pertaining to the product;
2) receiving said product information from said participants, which may be buyers and sellers, or both;
3) storing said product information received from said participants, which can be buyers and sellers, or both in a repository database;
4) making said product information accessible to other said participants, which may be prospective buyers and sellers, or both;
5) facilitating the consummation of commercial transactions between participating buyers and sellers, or both, including collecting a remitted payment;
6) redirecting a percentage of the remitted payment as a brokerage fee to participants associated with the consummated transaction;

2. The method of claim 1 further comprising the steps of:
1) arranging participants in a hierarchal organization of levels, with each higher level containing a smaller number of participants;
2) assigning associations between each participant located on a higher level with at least one participant on a lower level.

3. The method of claim 2 further comprising the step of:
1) assigning special associations between participants who recruit new participants and said new participants.

4. The method of claim 3 further comprising the steps of:
1) assigning special relationships between participants who are associated in separate social networks.

5. The method of claim 4 further comprising the steps of:
1) redirecting a percentage of the remitted payment as a brokerage fee to participants with special relationships with participants associated with the consummated transaction.

6. The method of claim 5 further comprising the steps of
1) assigning participants associated with consummated transactions a punctuation value in proportion to each consummated transaction with which they are associated;
2) adding assigned punctuation value to punctuation value previously accrued by said associated participant;
3) recording the total accrued punctuation value in said repository database.

7. The method of claim 6 further comprising the steps of:
1) assigning participants with special relationships with participants associated with consummated transactions a punctuation value in proportion to the each consummated transaction the participant with whom there exists a special relationship is associated;
2) adding assigned punctuation value to punctuation value previously accrued by said participant;
3) recording the total accrued punctuation value in said repository database.

8. The method of claim 7 further comprising the steps of:
1) determining the relative value of the total accrued punctuation value of each participant in each said hierarchal organization level;
2) reassigning a predetermining number of participants from each level, except the highest level, with relatively high punctuation values to the next higher level;
3) reassigning a predetermined number of participants from each level, except the lowest level, with relatively low punctuation values to the next lower level;
4) reassigning associations between each participant located on a higher level with at least one participant on a lower level.

9. The method of claim 8 further comprising the steps of:
1) reducing all participants punctuation values to zero to begin a new punctuation value accrual period.

10. The method of claim 9 further comprising the step of:
1) determining and imputing the boundary conditions that best foment electronic commerce by incentivizing buyers and sellers to loyally participate as well as recruit others to participate such as:
a. the percentage of the brokerage fee charged;
b. the percentage of the brokerage fee distributed among participants associated with the buyer;
c. the percentage of the brokerage fee distributed amount the seller;
d. the percentages of the brokerage fee that is distributed among participants with more attenuate associations, associated with either the buyer or seller or both;
e. the percentage of the brokerage fee that is distributed to those with special relationships such as a recruitment relationship or an association in a separate social network;
f. the punctuation value assigned for a consummated transactions, whether it be in proportion to transaction dollar value or quantity of consummated transactions or both;
g. the number of participants in each level that will be reassigned at the end of a punctuation value accrual period; and
h. the temporal duration of a punctuation value accrual period;

11. An apparatus for fomenting electronic commerce by incentivizing buyers and sellers to loyally participate as well as recruit others to participate, said apparatus comprising:
an input device for receiving communication from participating buyers and sellers regarding products offered for sale, products desired to be purchased, and information necessary to consummate transactions;
an output device for transmitting communication to participating buyers and sellers regarding products offered for sale, products desired to be purchased, and information necessary to consummate transactions;
a repository database for storing buyer and seller communication, relevant input, calculations, and boundary conditions;
firmware or a programmable computer, programmed with and capable of executing software or some combination thereof that prompts participants, which may be buyers and sellers, or both, to input information into the system regarding at least one product that the participant proposes to sell or wishes to purchase, including price, features, warranties, and other relevant information pertaining to the product; receives said product information from said participants, which may be buyers and sellers, or both; stores said product information received from said participants, which can be buyers and sellers, or both in said repository database; makes said product information available to other said participants, which may be prospective buyers and sellers, or both; facilitates the consummation of commercial transactions between participating buyers and sellers, or both, including collecting a remitted payment; and redirects a percentage of the remitted payment as a brokerage fee to participants associated with the consummated transaction.

12. An apparatus in claim 11 further comprising:
firmware or a programmable computer, programmed with and capable of executing software or some combination thereof that arranges participants in a hierarchal organization of levels, with each higher level containing a smaller number of participants and assigns associations between each participant located on a higher level with at least one participant on a lower level.

13. An apparatus in claim 12 further comprising:
firmware or a programmable computer, programmed with and capable of executing software or some combination thereof that assigns special associations between participants who recruit new participants and said new participants.

14. An apparatus in claim 13 further comprising:
firmware or a programmable computer, programmed with and capable of executing software or some combination thereof that assigns special relationships between participants who are associated in separate social networks.

15. An apparatus in claim 14 further comprising:
firmware or a programmable computer, programmed with and capable of executing software or some combination thereof that redirects a percentage of the remitted payment as a brokerage fee to participants with special relationships with participants associated with the consummated transaction.

16. An apparatus in claim 15 further comprising:
firmware or a programmable computer, programmed with and capable of executing software or some combination thereof that assigns participants associated with consummated transactions a punctuation value in proportion to each associated transaction consummated; adds the assigned punctuation value to punctuation value previously accrued by said participant; and records the total accrued punctuation value in said repository database.

17. An apparatus in claim 16 further comprising:
firmware or a programmable computer, programmed with and capable of executing software or some combination thereof that assigns participants with special relationships with participants associated with consummated transactions a punctuation value in proportion to each consummated transaction the participant with whom there exists a special relationship is associated; adds the assigned punctuation value to punctuation value previously accrued by said participant; and records the total accrued punctuation value in said repository database.

18. An apparatus in claim 17 further comprising:
firmware or a programmable computer, programmed with and capable of executing software or some combination thereof that periodically determines the relative value of the total accrued punctuation value of each participant in each said hierarchal organization level; reassigns a predetermining number of participants from each level, except the highest level, with relatively high punctuation values to the next higher level; reassigns a predetermined number of participants from each level, except the lowest level, with relatively low punctuation values to the next lower level; and reassigns associations between each participant located on a higher level with at least one participant on a lower level.

19. An apparatus in claim 18 further comprising:
firmware or a programmable computer, programmed with and capable of executing software or some combination thereof that periodically reduces all participants' punctuation values to zero to begin a new punctuation value accrual period.

20. An apparatus in claim 19 further comprising:
firmware or a programmable computer, programmed with and capable of executing software or some combination thereof that receives and executes the boundary conditions that best foment electronic commerce by incentivizing buyers and sellers to loyally participate as well as recruit others to participate such as:
a. the percentage of the brokerage fee charged;
b. the percentage of the brokerage fee distributed among participants associated with the buyer;
c. the percentage of the brokerage fee distributed amount the seller;
d. the percentages of the brokerage fee that is distributed among participants with more attenuate associations, associated with either the buyer or seller or both;
e. the percentage of the brokerage fee that is distributed to those with special relationships such as a recruitment relationship or an association in a separate social network;
f. the punctuation value assigned for consummated transactions, whether it be in proportion to transaction dollar value or quantity of transactions or both;
g. the number of participants in each level that will be reassigned at the end of a punctuation value accrual period; and
h. the temporal duration of a punctuation value accrual period;
